(19) United States
(12) Patent Application Publication
(10) Pub. No.: US 2019/0381879 A1
(43) Pub. Date: Dec. 19, 2019

(54) CLUTCH HAVING A TORQUE INTRODUCTION PART SUPPORTED ON THE TORQUE TRANSMISSION PART

(71) Applicant: Schaeffler Technologies AG & Co. KG, Herzogenaurach (DE)

(72) Inventors: Marcus Hoppe, Achern (DE); Torsten Pieper, Karlsruhe (DE)

(73) Assignee: Schaeffler Technologies AG & Co. KG, Herzogenaurach (DE)

(21) Appl. No.: 16/480,360

(22) PCT Filed: Feb. 22, 2018
(86) PCT No.: PCT/DE2018/100150

§ 371 Date: Jul. 24, 2019

(30) Foreign Application Priority Data
Mar. 6, 2017 (DE) 10 2017 104 573.2
Dec. 8, 2017 (DE) 10 2017 129 266.7

(51) Int. Cl. B60K 6/387; F16D 13/52; F16D 25/12

(52) U.S. Cl. CPC B60K 6/387; F16D 13/52; B60Y 2400/424; B60Y 2200/92; F16D 25/12

(57) ABSTRACT

A clutch for a drive train of a motor vehicle includes a bearing, a torque transmission part, a torque output part, and a torque introduction part. The torque output part is connected to the torque transmission part in a non-rotational manner. The torque introduction part is connectable to the torque output part for torque transfer, and supported on the torque transmission part by the bearing.

### CROSS-REFERENCE TO RELATED APPLICATIONS

This application is the United States National Phase of PCT Appln. No. PCT/DE2018/100150 filed Feb. 22, 2018, which claims priority to German Application Nos. DE102017104573.2 filed Mar. 6, 2017 and DE102017129266.7 filed Dec. 8, 2017, the entire disclosures of which are incorporated by reference herein.

### TECHNICAL FIELD

The present disclosure relates to a clutch for a drive train of a motor vehicle, having a torque introduction part which can be connected to a torque output part for torque transfer. The torque introduction part is connected to a torque transmission part in a non-rotational manner and supported on the torque transmission part by a bearing. The disclosure also relates to a hybrid module for a drive train of a motor vehicle having a first drive assembly, such as an internal combustion engine, for example, and a second drive assembly, such as an electric machine, for example, which can be connected to a drive shaft in a torque-transmitting manner by a clutch.

### BACKGROUND

Hybrid modules should be distinguished from drive assemblies, customarily an internal combustion engine and an electric machine, in terms of their arrangement structure. Hence, for example, a P2 arrangement should be understood to mean an arrangement in which the electric machine is not installed directly on the internal combustion engine, but is located at the gearbox input with a clutch lying therebetween. In this way, the internal combustion engine can be decoupled from the remaining drive train and electric travel and recuperation are possible within a substantially more efficient framework, without the drag torque losses of the internal combustion engine. Hybrid modules of this kind are then also customarily referred to as P2 hybrid modules.

In addition, a distinction is made in the case of hybrid modules between axis-parallel and coaxial hybrid modules. With axis-parallel hybrid modules, the output shafts of the two drive assemblies, usually an internal combustion engine and an electric machine, are oriented parallel to one another. In the case of coaxial hybrid modules, these output shafts are arranged coaxially, in other words in alignment with one another. This means that they have the same rotational axis.

DE 10 2015 211 436 A1 relates to a drive arrangement having an input element for connection to an internal combustion engine and an electric machine, and having an output element for connection of the drive assembly to a gearbox input shaft of a subordinate gearbox. A friction clutch is provided as the start-up element, which friction clutch couples the rotor of the electric machine to the output element and to a pawl-type coupling, which couples the internal combustion engine to the input element of the friction clutch when the friction clutch is closed. An actuating means for the friction clutch and an actuating means for the pawl-type coupling are provided which can be acted upon by an actuating element. The actuating element can be shifted in a first actuating direction, in order to act upon the actuating means for actuation of the pawl-type coupling, and can be displaced in a second actuating direction, in order to act upon the actuating means for actuation of the friction clutch.

When it comes to clutch design, a distinction is made between a drive side (e.g. an internal combustion engine) and an output side (e.g. the gearbox). With both dry and wet clutches, the clutch plate(s) is/are connected to the gearbox input shaft via a fitting tooth system, for example.

In the case of dry clutches, the clutch plates are axially displaceable, in order to provide sufficient free travel and displaceability in case of lining wear.

In the case of wet clutches, the disk carriers which guide the friction disks are mainly supported by axial bearings. However, the drive side and the output side are not radially centered in respect of one another. This state occurs only when the clutch is closed.

### SUMMARY

Example embodiments broadly comprise a generic clutch including a torque introduction part that is supported on the torque transmission part by a bearing. In this way, the torque introduction part is centered in relation to the torque transmission component and therefore at the same time also in relation to the torque output component. The torque introduction part may be configured as an outer disk carrier and the torque output part may be configured as an inner disk carrier and/or the torque transmission part may be one-part or a multi-part design.

In addition, the torque transmission part may have a hub and a shaft. The hub is mounted on the shaft in a torque-transmitting manner, by means of a fitting tooth system, for example. In this way, the clutch can be mounted on the hub beforehand, for example, and the hub can then be pushed onto the shaft along with the clutch mounted thereupon as a structural unit.

The bearing may be configured as a roller bearing or as a sliding bearing. An inner ring of the bearing may be formed integrally/in one piece with the hub. In this way, the centering play from the outer disk carrier to the hub can be further reduced.

The bearing may be in contact with an outer surface of the shaft or hub. Consequently, the bearing can be used for the axial securing of the hub on the shaft, for example, as a result of which the locking screw or the circlip can be dispensed with. The bearing may abut the hub laterally so that forces in the radial and axial directions can be absorbed. The hub may be forcibly guided on the (intermediate) shaft through a centering region.

The hybrid module may include an outer disk carrier or an inner disk carrier that is prepared for direct contact with a continuous traction means such as a belt or a chain, for example. In this way, the electric machine can be connected straight to the clutch in a torque-transmitting manner via a continuous traction means.

In other words, the disclosure involves the outer disk carrier being mounted on the hub via a bearing, e.g. grooved ball bearing or angular ball bearing, and thereby centered thereto. The hub is simultaneously used as a carrier for the inner disk carrier, as a result of which outer and inner disk carriers are centered and positioned both radially and axially in respect of one another. Another embodiment envisages that the inner ring of the bearing can be integrated in the hub. In this way, the centering play from the outer disk carrier to the shaft could be further reduced. A third embodiment envisages that the hub is connected to the shaft free from play (axial and radial). This means that it would be conceivable for the bearing for the outer disk carrier to be mounted straight on the shaft. This means that either the locking screw or the circlip could be dispensed with.

It can therefore also be said that the disclosure involves an outer disk carrier of a separating clutch of a hybrid module being arranged and centered on a hub via a bearing. In addition, the hub is also used as a carrier for an inner disk carrier of the separating clutch, so that the inner disk carrier and the outer disk carrier are thereby centered and positioned axially and radially in respect of one another. In this way, clean functioning/action of the separating clutch can be guaranteed.

### BRIEF DESCRIPTION OF THE DRAWINGS

The disclosure is explained in greater detail below with the help of figures in which different embodiments are depicted. In the figures:

FIG. 1 shows a longitudinal section of a hybrid system;

FIG. 2 shows the longitudinal section of the hybrid system from FIG. 1 as a perspective representation;

FIG. 3 shows the longitudinal section of the hybrid module from FIG. 1 to explain causal relations and also operating methods;

FIG. 4 shows a partial region with an intermediate shaft of the hybrid module;

FIG. 5 shows a first exemplary embodiment of a clutch;

FIG. 6 shows a second exemplary embodiment of the clutch; and

FIG. 7 shows a third exemplary embodiment of the clutch.

### DETAILED DESCRIPTION

The figures are only schematic in nature and serve only to provide an understanding of the invention. The same components are provided with the same reference numbers. Features of the individual exemplary embodiments may also be realized in different exemplary embodiments. They are therefore mutually exchangeable.

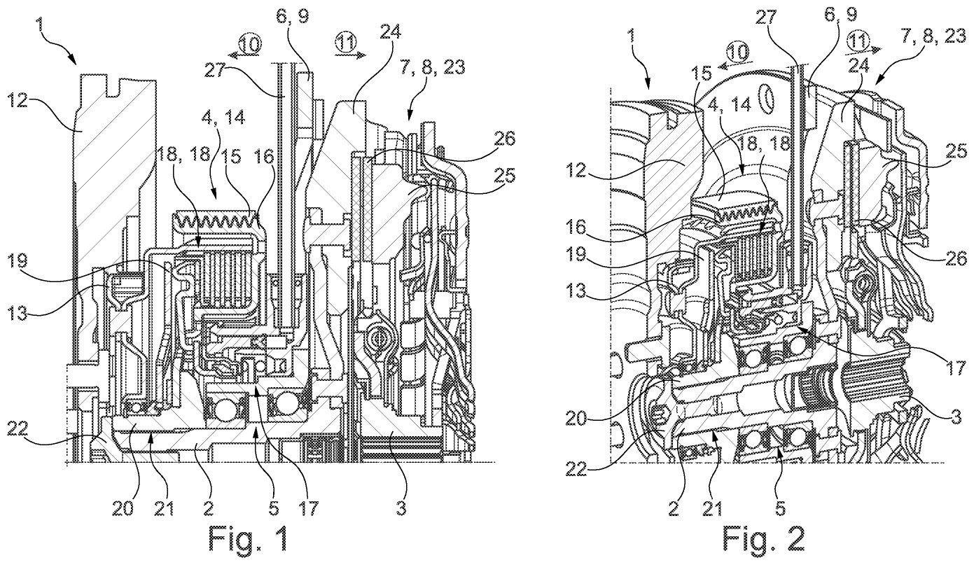

FIGS. 1 and 2 show a longitudinal section of a hybrid module 1 as a sectional view (FIG. 1) or as a perspective view (FIG. 2). The hybrid module 1 has an intermediate shaft 2 and also a drive shaft 3 separate therefrom. The drive shaft 3 is used as the gearbox input shaft. It is possible for a first drive assembly (not shown) and/or a second drive assembly (not shown) to be connected to the intermediate shaft 2 in a torque-transmitting manner via a separating clutch 4 which is mounted on the intermediate shaft 2. The intermediate shaft 2 is supported on a housing 6 of the hybrid module 1 via a support bearing 5. A start-up element 7, likewise in the form of a clutch 8, is connected to the drive shaft 3 and the intermediate shaft 2.

The housing 6 has an intermediate wall 9, in respect of which the hybrid module 1 can be divided up into an engine side 10 and a gearbox side 11. The first drive assembly and the second drive assembly which are not shown here are located on the engine side 10. An internal combustion engine which is connected to an outer disk carrier 13 which separating clutch 4 configured as a disk clutch 14 via a dual mass flywheel which is attached to a crankshaft (not shown) of the internal combustion engine is used as the first drive unit, for example.

The second drive assembly is configured in the form of an electric machine such as an electric motor (not shown), for example, and connected to the separating clutch 4 in a torque-transmitting manner via a belt 15 with an inner disk carrier 16. The separating clutch 4 is actuated via a release/engagement device 17. The disk sets 18 (friction and steel disks) are pretensioned by a plate spring 19.

The separating clutch 4 is arranged as a complete unit on a hub 20 which is connected to the intermediate shaft 2 in a torque-transmitting manner via a shaft-hub connection 21. The hub 20 is secured to prevent axial displacement by means of a central or locking screw 22.

The start-up element 7, in the embodiment shown, is located on the gearbox side 11 and is configured as a single clutch 23. The single clutch 23 is connected to the intermediate shaft 2 via a flywheel 24 which has a two-part design in this case. The single clutch 23 is connected to the drive shaft 3 in a torque-transmitting manner by means of a clutch plate 25 and a friction element 26.

The separating clutch 4 may also be referred to as a K0 clutch and the clutch 8 may also be referred to as a K1 clutch. In order to actuate the release/engagement device 17 of the separating clutch 4, the housing 6 has a line 27 by means of which a hydraulic medium can be supplied, for example.

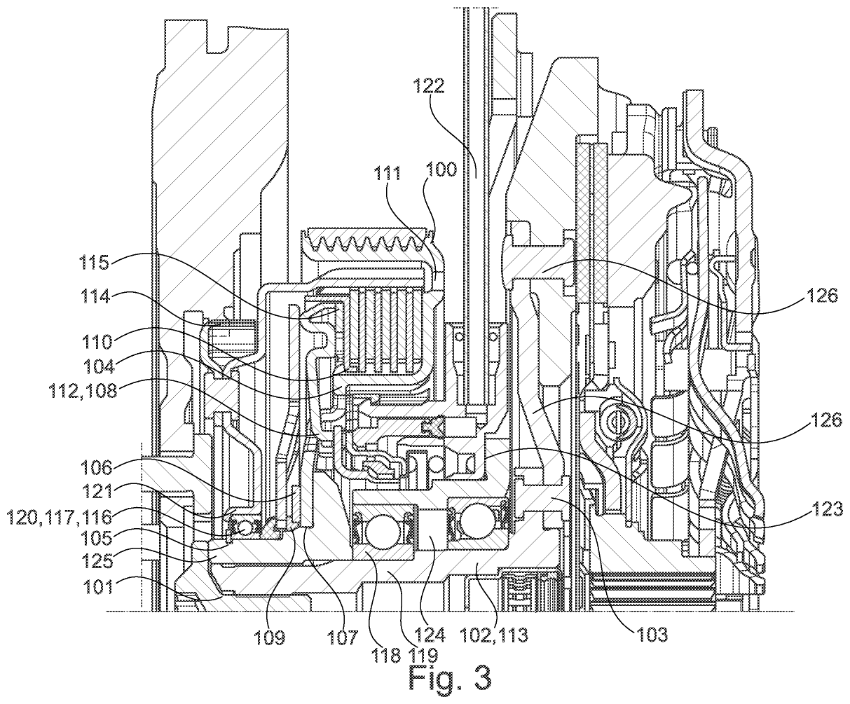

FIG. 3 shows the identical view to FIG. 1, wherein in this case attention is paid to causal relations. In this case, reference number 100 denotes that a belt pulley and a disk carrier have a one-part or multi-part configuration. Reference number 101 denotes that axial securing and force support of a separating clutch is performed by means of a screw connection to an intermediate shaft. Reference number 102 denotes an intermediate shaft as the support (radial and axial) for a clutch cover, a twin clutch, a converter, etc. Reference number 103 denotes a screw connection, rivet connection or welded connection, etc. of a flywheel and, for example, of a clutch cover, a twin clutch or a converter, etc., to the intermediate shaft. Reference number 104 denotes an inner disk carrier which is used as a wear abutment for a pressure pot.

Reference number 105 denotes that removal of the separating clutch from the intermediate shaft is possible using a groove for a circlip (or a separate groove) and a thread of the intermediate shaft. Reference number 106 denotes that a rivet connection of the disk carrier to a hub is simultaneously used to center a plate spring. Reference number 107 denotes that the disk carrier is connected to the hub by means of a separate centering diameter. Reference number 108 denotes that an inner disk carrier is also used as an abutment for an engagement system. Reference number 109 denotes that tolerance compensation of a plate spring force is achieved by means of shims of different heights of a support ring. Reference number 110 denotes that an axial installation space saving is achieved by means of bent feet (tooth system) of a pressure plate. Reference number 111 denotes that the inner disk carrier exhibits additional holes for pins, so that friction disks can be positioned during assembly. Reference number 112 denotes that the inner disk carrier is used for centering the pressure pot.

Reference number 113 denotes that where a twin clutch acts as a starting clutch, a support bearing of the separating clutch also takes over the mounting of the twin clutch. The twin clutch has a fixed connection to an inner shaft of the separating clutch. No twin clutch bearing (on a gear shaft) is provided. Reference number 114 denotes that no pretensioning device of a dual mass flywheel and a separating clutch is provided. Gear noises only occur when idling. Idling of the internal combustion engine is not an operating mode which is provided for. With the electric machine, there may constantly be a moment on a tooth system.

Reference number 115 denotes that a pressure plate is used as a centering means for a modulation spring. Reference number 116 denotes that a hub is used as a carrier for a bearing for an outer disk carrier. Reference number 117 denotes that an inner ring of the bearing of the outer disk carrier is integrated in the hub. Reference number 118 denotes that an inner ring of the bearing, e.g. a grooved ball bearing, of the intermediate shaft is integrated in the hub. Reference number 119 denotes that the hub is used as a carrier for a support bearing.

Reference number 120 denotes that the bearing for the outer disk carrier is separately mounted on an intermediate shaft and not on the hub. Reference number 121 denotes that the outer disk carrier is used as an outer ring for bearings, e.g. a sheet-metal bearing. Reference number 122 denotes that a line for a central release mechanism or CSC or Concentric Slave Cylinder disappears in a sheet-metal or material thickness of an intermediate wall. Reference number 123 denotes that the central release mechanism with a flange and a bearing carrier unit is screwed, riveted or welded to the intermediate wall. The central release mechanism is only fitted on top and not screwed on.

Reference number 124 denotes that an installation space is used between bearings of the intermediate shaft and the intermediate wall for measuring torque, temperature, speed, position (resolver), etc., or for mechanisms for measuring the values of these variables. Reference number 125 denotes that the separating clutch can be dismantled without dismantling the hybrid module. Alternatively, the separating clutch and the starting clutch may be a supply unit including the intermediate wall and the rotor of the electric machine. Likewise, a complete module with housing, stator, cooling, electronics, actuator, etc., may be provided. Reference number 126 denotes that a flywheel for the starting clutch has a two-part design, in order to save axial installation space. A riveted connection of cast iron with sheet metal is possible outside, inside or below a frictional surface.

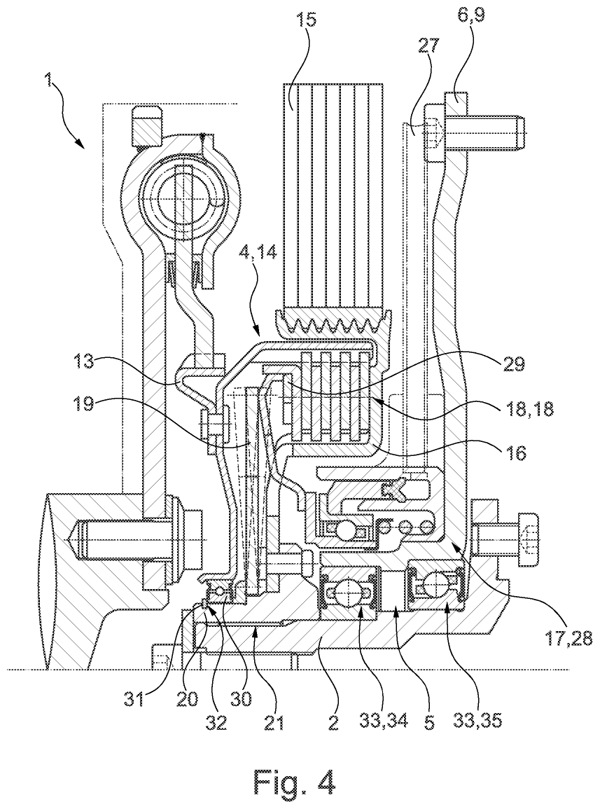

FIG. 4 shows a detail of the hybrid module 1 in the region of the intermediate shaft 2 as a longitudinal sectional view. The separating clutch 4, which can also be referred to as the K0 clutch, is a “normally closed” clutch in the embodiment shown here with a CSC (Concentric Slave Cylinder) or a slave cylinder 28 as a release/engagement device 17. The separating clutch 4, which is configured as a disk clutch 14, may also be configured as a dry clutch or as a wet clutch. The inner disk carrier 16, as referred to above, may be used as a belt pulley carrier for the belt 15. Alternatively, particularly for a coaxial hybrid system (not shown), the inner disk carrier 16 may also be used as the rotor carrier of the electric machine. Moreover, a modulation spring 29 can be provided.

The outer disk carrier 13 is mounted on a hub 20 by means of a bearing 30. The bearing 30 is secured to prevent axial displacement by means of a circlip 31 which is inserted in a corresponding groove 32 in the hub 20. The intermediate shaft 2 is supported on the housing 6, more precisely on the intermediate wall 9, by means of the support bearing 5. The support bearing 5 in the embodiment shown here has two bearings 33, one of which is configured as a grooved ball bearing 34 and the second as an angular ball bearing 35.

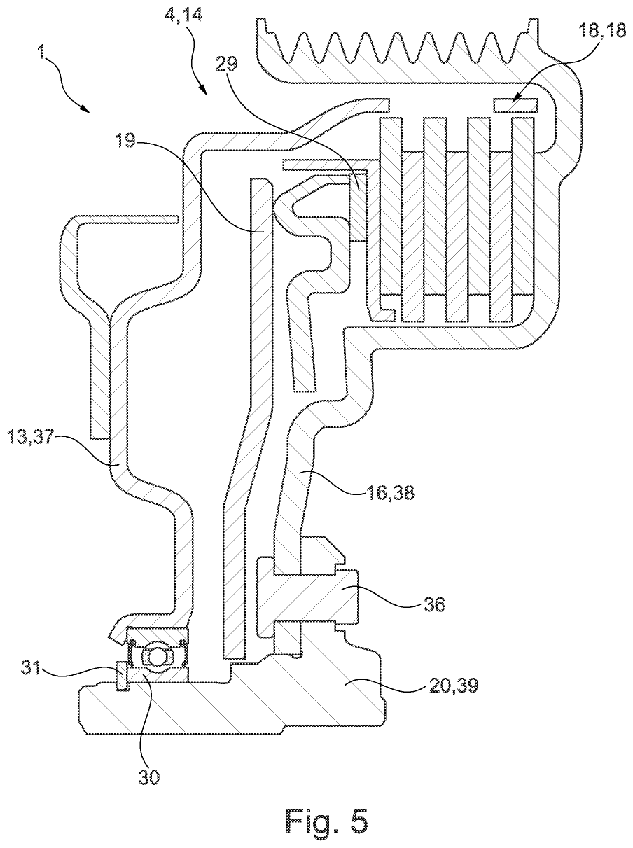

FIG. 5 shows a first embodiment of the hybrid module 1 in the region of the hub 20 and the separating clutch 4 mounted or else arranged thereon. In the embodiment shown here, the outer disk carrier 13 is supported on the hub 20 by means of the bearing 30, wherein the hub 20 is connected to the intermediate shaft 2 by means of the shaft-hub connection 21 (see FIG. 4) in a torque-transmitting manner. The inner disk carrier 16 in this case is fixedly connected to the hub 20 by means of a rivet 36. The bearing 30 of the outer disk carrier 13 is secured on the hub 20 to prevent axial displacement by means of the circlip 31, as mentioned previously.

Consequently, both the outer disk carrier 13, which is used as the torque introduction part 37, and the inner disk carrier 16, which is used as the torque output part 38, are mounted on the hub 20, which is used as the torque transmission part 39 or as part of the torque transmission part 39, and centered in respect of the hub 20. In this way, the outer disk carrier 13 and the inner disk carrier 16 are also centered in respect of one another.

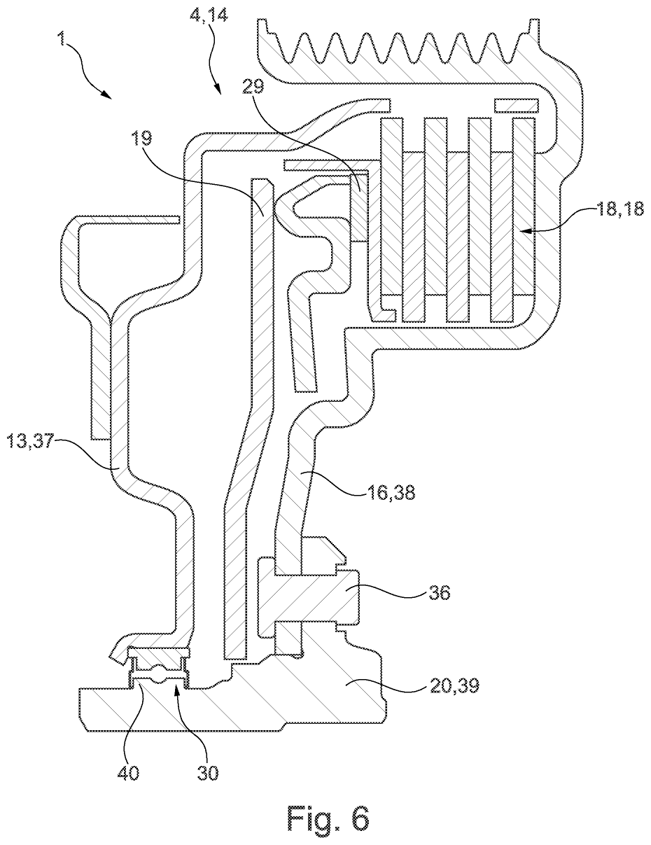

FIG. 6 shows a second exemplary embodiment of the region of the hybrid module 1 shown in FIG. 5 and corresponds for the most part to the first embodiment shown in FIG. 5. Unlike the first embodiment, in the second embodiment shown here, an inner ring 40 of the bearing 30 is configured integrally or as one piece with the hub 20. In this way, the centering play from the outer disk carrier 13 to the hub 20 is further reduced.

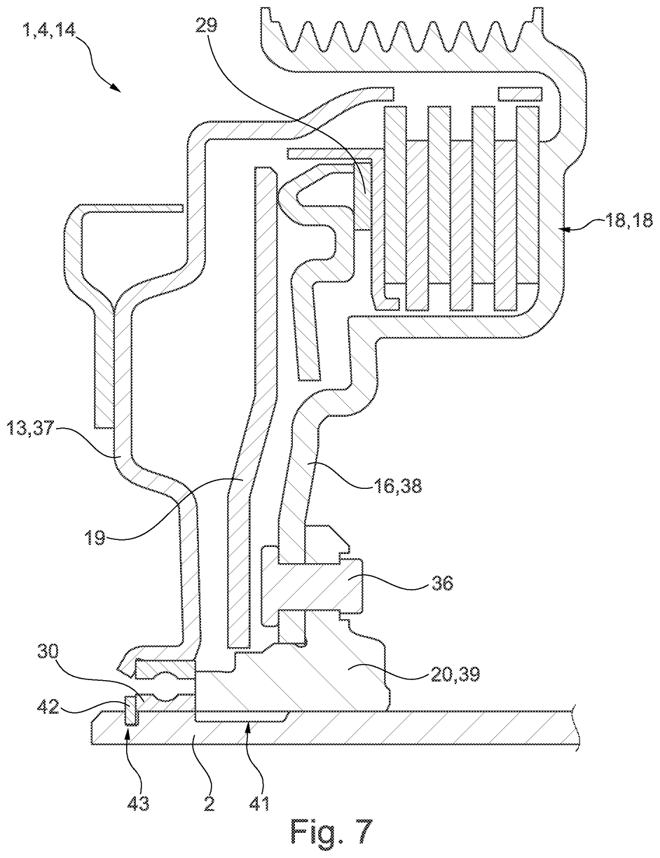

FIG. 7 shows a third exemplary embodiment of the hybrid module 1 in the region of the intermediate shaft 2. The third embodiment shown here differs from the first and second embodiments shown in FIG. 5 and FIG. 6 in that the hub 20 is centered and positioned relative to the intermediate shaft 2 by means of a centering region 41 and the bearing 30 is arranged directly on the intermediate shaft 2. Here, too, the bearing 30 is secured to prevent axial displacement by means of a circlip 42 which is inserted into a groove 43 in the intermediate shaft 2. Since the bearing 30 can be positioned directly on the intermediate shaft 2, it is used for the axial displacement of the hub 20 in relation to the intermediate shaft 2 and thereby replaces the central screw 22 shown in FIG. 1 and FIG. 2.

### REFERENCE NUMERALS

1 Hybrid module

2 Intermediate shaft

3 Drive shaft

4 Separating clutch

5 Support bearing

6 Housing

7 Start-up element

8 Clutch

9 Intermediate wall

10 Engine side

11 Gearbox side

12 Dual mass flywheel

13 Outer disk carrier

14 Multi-disk clutch

15 Belt

16 Inner disk carrier

17 Release/engagement device

18 Set of disks

19 Plate spring

20 Hub

21 Shaft-hub connection

22 Central/locking screw

23 Single clutch

24 Flywheel

25 Clutch plate

26 Friction element

27 Line

28 Slave cylinder (CSC)

29 Modulation spring

30 Bearing

31 Circlip

32 Groove

33 Bearing

34 Grooved ball bearing

35 Angular ball bearing

36 Rivet

37 Torque introduction part

38 Torque output part

39 Torque transmission part

40 Inner ring

41 Centering region

42 Circlip

43 Groove

101 Screw connection

102 Intermediate shaft

103 Screw connection/rivet connection/welded connection

104 Inner disk carrier

105 Groove

106 Rivet connection

107 Centering diameter

108 Abutment

109 Support ring

110 Tooth system

111 Hole

112 Pressure pot centering

113 Support bearing

114 Tooth system

115 Pressure plate

116 Hub

117 Inner ring

118 Inner ring

119 Hub

120 Bearing

121 Outer ring

122 Intermediate wall

123 Central release mechanism

124 Installation space

1.-10. (canceled)

11. A clutch for a drive train of a motor vehicle, comprising:
a bearing;
a torque transmission part;
a torque output part connected to the torque transmission part in a non-rotational manner;
a torque introduction part:
connectable to the torque output part for torque transfer; and
supported on the torque transmission part by the bearing.

12. The clutch of claim 11, wherein:
the torque introduction part is an outer disk carrier; and
the torque output part is an inner disk carrier.

13. The clutch of claim 11, wherein the torque transmission part is one part formed from a single piece of material.

14. The clutch of claim 11, wherein the torque transmission part is of multi-part design.

15. The clutch of claim 14, wherein the torque transmission part comprises:
an intermediate shaft; and
a hub mounted on the intermediate shaft in a torque-transmitting manner.

16. The clutch of claim 15, wherein the bearing is a roller bearing or a sliding bearing.

17. The clutch of claim 16, wherein the bearing comprises an inner ring formed integrally with the hub.

18. The clutch of claim 16, wherein:
the intermediate shaft or the hub comprises an outer surface; and
the bearing contacts the outer surface.

19. The clutch of claim 18, wherein the bearing laterally abuts the hub so that radial forces and axial forces are absorbed.

20. The clutch of claim 15 wherein the hub is forcibly guided on the intermediate shaft through a centering region.

21. A hybrid module for a drive train of a motor vehicle comprising a first drive assembly and a second drive assembly connectable to a drive shaft in a torque-transmitting manner by the clutch according of claim 11.

22. The hybrid module of claim 21 wherein an inner disk carrier is prepared for contact with a continuous traction means.

23. A clutch for a hybrid vehicle comprising:
a hub;
a bearing;
an inner disk carrier fixed to the hub; and
an outer disk carrier connectable to the inner disk carrier for torque transmission and radially supported on the hub by the bearing.

24. The clutch of claim 23 further comprising:
disk sets arranged radially between the inner disk carrier and the outer disk carrier; and
a plate spring for compressing the disk sets to connect the outer disk carrier to the inner disk carrier for torque transmission.

25. The clutch of claim 23 further comprising an intermediate shaft connected to the hub in a torque transmitting manner at a shaft-hub connection.

26. The clutch of claim 25 wherein the hub is radially supported on the intermediate shaft at a centering region.

27. The clutch of claim 23 further comprising a circlip, wherein:
the hub comprises a groove; and
the circlip is inserted in the groove to prevent axial displacement of the bearing.

28. The clutch of claim 23 wherein the inner disk carrier comprises a pulley carrier for receiving a belt to connect the inner disk carrier to an electric machine in a torque transmitting manner.

29. The clutch of claim 28 further comprising disk sets arranged radially between the inner disk carrier and the outer disk carrier, wherein the pulley carrier is at least partially aligned with the disk sets in a radial direction.

30. The clutch of claim 23 further comprising a hydraulic concentric slave cylinder for actuating the clutch.
